(19) United States
(12) Patent Application Publication
(10) Pub. No.: US 2010/0332598 A1
(43) Pub. Date: Dec. 30, 2010

(54) Routing Videoconference Signals Based on Network Configurations

(76) Inventors: Ashish Goyal, Bangalore (IN); Hrishikesh G. Kulkarni, Bangalore (IN)

Correspondence Address: MEYERTONS, HOOD, KIVLIN, KOWERT & GOETZEL, P.C., P.O. BOX 398, AUSTIN, TX, 78767-0398, US

(21) Appl. No.: 12/822,680

(22) Filed: Jun. 24, 2010

Related U.S. Application Data
(60) Provisional application No. 61/220,345, filed on Jun. 25, 2009.

(51) Int. Cl. G06F 15/16

(52) U.S. Cl. 709/205

(57) ABSTRACT

Performing a videoconference based on network locality. The method may determine if a first endpoint and a second endpoint is within a same network, e.g., based on the address of the first and second endpoints. The videoconference may be established or performed based on the determination. For example, an external communication server may be used if the second endpoint is not within the same network as the first endpoint. However, the external communication server may be bypassed if the second endpoint is within the same network as the first endpoint.

### PRIORITY INFORMATION

This application claims benefit of priority of U.S. provisional application Ser. No. 61/220,345 titled “Routing Videoconference Signals Based on Network Configurations” filed Jun. 25, 2009, whose inventors were Ashish Goyal and Prithvi Ranganath, which is hereby incorporated by reference in its entirety as though fully and completely set forth herein.

### FIELD OF THE INVENTION

The present invention relates generally to conferencing and, more specifically, to a system and method for routing videoconferencing signals based on network configurations.

### DESCRIPTION OF THE RELATED ART

Videoconferencing may be used to allow two or more participants at remote locations to communicate using both video and audio. Each participant location may include a videoconferencing system for video/audio communication with other participants. Each videoconferencing system may include a camera and microphone to collect video and audio from a first or local participant to send to another (remote) participant. Each videoconferencing system may also include a display and speaker to reproduce video and audio received from one or more remote participants. Each videoconferencing system may also be coupled to (or comprise) a general purpose computer system to allow additional functionality into the videoconference. For example, additional functionality may include data conferencing (including displaying and/or modifying a document for both participants during the conference).

Currently, some networks include servers which allow an endpoint to communicate to another endpoint outside of the network. In such networks, all network traffic of a videoconference may be routed through the server system. However, such routing may be inefficient. Correspondingly, improvements in videoconferencing are desired.

### SUMMARY OF THE INVENTION

Various embodiments are presented of a method for routing videoconferencing signals based on network configurations.

In a first embodiment, the method may be performed by a server. More specifically, a server system may detect a videoconference (e.g., a H.460 protocol videoconference) between a first endpoint and a second endpoint. For example, the server system may receive a request to establish the videoconference between the first endpoint and the second endpoint (e.g., from the first endpoint). The first endpoint and the second endpoint may be on the same network and the server system may be configured to provide videoconference communication external to the network for the first endpoint and the second endpoint. Thus, in this embodiment, the server may be used for (e.g., dedicated to) providing videoconference communication to external endpoints, but may not be appropriate since the first and second endpoints are within the same network.

Accordingly, the server system may determine that the first endpoint and the second endpoint are within the same network and may provide an indication to the first endpoint to provide videoconferencing signals of the videoconference to the second endpoint without utilizing the server system. Thus, after providing the indication, the first endpoint may provide the videoconferencing signals of the videoconference to the second endpoint (e.g., directly) without using the server system.

The determination that the first endpoint and the second endpoint are within the same network may be performed in an automatic fashion by the server system based on an IP address of the first endpoint and an IP address of the second endpoint. In one embodiment, a configuration file(s) (e.g., stored by the server system) may define a range of IP addresses that are common to the same network. Accordingly, the IP address of the first endpoint and the IP address of the second endpoint fall within the range of IP addresses when they are on the same network. Accordingly, the server system may determine that the two endpoints are on the same network by comparing the IP addresses of the two endpoints with the IP addresses stored in the configuration file. In order to perform this determination, the server system may receive the range of IP addresses in an automatic fashion or based on user input, as desired.

In a second embodiment, the method may be performed by an endpoint. For example, a first endpoint may receive a request to establish the videoconference (e.g., which may use an H.460 protocol). The request may include an address (e.g., an IP address) of a second endpoint that is to participate in the videoconference.

The method (e.g., the first endpoint) may determine whether the second endpoint is within the same network as the first endpoint based on the address of the second endpoint. For example, the method may compare the address of the second endpoint with a known list of addresses that are on the same network. More specifically, a configuration file may be used which defines a range of addresses that are common to the same network and the determination may be performed by determining whether address of the second endpoint falls within the range of IP addresses. This range of IP addresses may be determine automatically (e.g., by the first endpoint) or may be defined manually, e.g., by an administrator.

The videoconference may then be established (e.g., by the first endpoint) with the second endpoint based on this determination. More particularly, the conference may be established using an external communication server if the second endpoint is not within the same network as the first endpoint or the conference may be established without using (bypassing) the external communication server if the second endpoint is within the same network as the first endpoint.

### BRIEF DESCRIPTION OF THE DRAWINGS

A better understanding of the present invention may be obtained when the following detailed description is considered in conjunction with the following drawings, in which:

FIG. 1 illustrates a videoconferencing system participant location, according to an embodiment;

FIGS. 2A and 2B illustrate exemplary coupled conferencing systems, according to an embodiment;

FIG. 3 is a flowchart diagram illustrating an exemplary method for routing videoconferencing signals by a server system, according to an embodiment;

FIG. 4 is a flowchart diagram illustrating an exemplary method for establishing a videoconference by an endpoint; and

FIGS. 5-8 are exemplary screen shots corresponding to the methods illustrated in FIGS. 3 and 4.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note that the headings are for organizational purposes only and are not meant to be used to limit or interpret the description or claims. Furthermore, note that the word “may” is used throughout this application in a permissive sense (i.e., having the potential to, being able to), not a mandatory sense (i.e., must). The term “include”, and derivations thereof, mean “including, but not limited to”. The term “coupled” means “directly or indirectly connected”.

### DETAILED DESCRIPTION OF THE EMBODIMENTS

### Incorporation by Reference

U.S. patent application titled “Video Conferencing System Transcoder”, Ser. No. 11/252,238, which was filed Oct. 17, 2005, whose inventors are Michael L. Kenoyer and Michael V. Jenkins, is hereby incorporated by reference in its entirety as though fully and completely set forth herein.

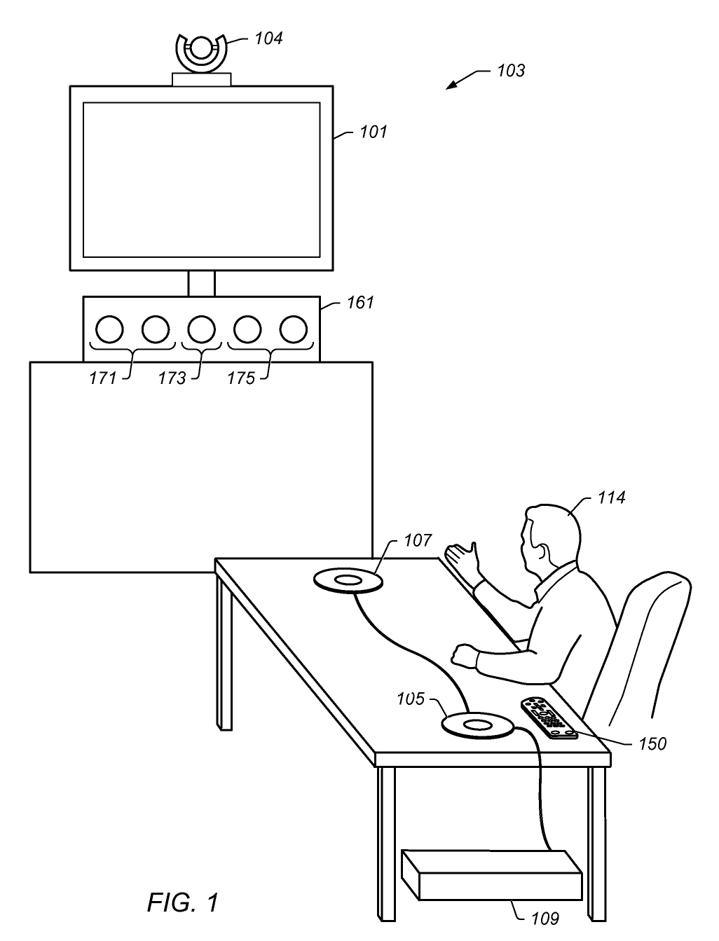

### FIG. 1—Exemplary Participant Location

FIG. 1 illustrates an exemplary embodiment of a videoconferencing participant location, also referred to as a videoconferencing endpoint or videoconferencing system (or videoconferencing unit). The videoconferencing system 103 may have a system codec 109 to manage both a speakerphone 105/107 and videoconferencing hardware, e.g., camera 104, display 101, speakers 171, 173, 175, etc. The speakerphones 105/107 and other videoconferencing system components may be coupled to the codec 109 and may receive audio and/or video signals from the system codec 109.

In some embodiments, the participant location may include camera 104 (e.g., an HD camera) for acquiring images (e.g., of participant 114) of the participant location. Other cameras are also contemplated. The participant location may also include display 101 (e.g., an HDTV display). Images acquired by the camera 104 may be displayed locally on the display 101 and/or may be encoded and transmitted to other participant locations in the videoconference.

The participant location may also include a sound system 161. The sound system 161 may include multiple speakers including left speakers 171, center speaker 173, and right speakers 175. Other numbers of speakers and other speaker configurations may also be used. The videoconferencing system 103 may also use one or more speakerphones 105/107 which may be daisy chained together.

In some embodiments, the videoconferencing system components (e.g., the camera 104, display 101, sound system 161, and speakerphones 105/107) may be coupled to a system codec 109. The system codec 109 may be placed on a desk or on a floor. Other placements are also contemplated. The system codec 109 may receive audio and/or video data from a network, such as a LAN (local area network) or the Internet. The system codec 109 may send the audio to the speakerphone 105/107 and/or sound system 161 and the video to the display 101. The received video may be HD video that is displayed on the HD display. The system codec 109 may also receive video data from the camera 104 and audio data from the speakerphones 105/107 and transmit the video and/or audio data over the network to another conferencing system. The conferencing system may be controlled by a participant or user through the user input components (e.g., buttons) on the speakerphones 105/107 and/or remote control 150. Other system interfaces may also be used.

In various embodiments, a codec may implement a real time transmission protocol. In some embodiments, a codec (which may be short for “compressor/decompressor”) may comprise any system and/or method for encoding and/or decoding (e.g., compressing and decompressing) data (e.g., audio and/or video data). For example, communication applications may use codecs for encoding video and audio for transmission across networks, including compression and packetization. Codecs may also be used to convert an analog signal to a digital signal for transmitting over various digital networks (e.g., network, PSTN, the Internet, etc.) and to convert a received digital signal to an analog signal. In various embodiments, codecs may be implemented in software, hardware, or a combination of both. Some codecs for computer video and/or audio may include MPEG, Indeo™, and Cinepak™, among others.

In some embodiments, the videoconferencing system 103 may be designed to operate with normal display or high definition (HD) display capabilities. The videoconferencing system 103 may operate with a network infrastructures that support T1 capabilities or less, e.g., 1.5 mega-bits per second or less in one embodiment, and 2 mega-bits per second in other embodiments.

Note that the videoconferencing system(s) described herein may be dedicated videoconferencing systems (i.e., whose purpose is to provide videoconferencing) or general purpose computers (e.g., IBM-compatible PC, Mac, etc.) executing videoconferencing software (e.g., a general purpose computer for using user applications, one of which performs videoconferencing). A dedicated videoconferencing system may be designed specifically for videoconferencing, and is not used as a general purpose computing platform; for example, the dedicated videoconferencing system may execute an operating system which may be typically streamlined (or “locked down”) to run one or more applications to provide videoconferencing, e.g., for a conference room of a company. In other embodiments, the videoconferencing system may be a general use computer (e.g., a typical computer system which may be used by the general public or a high end computer system used by corporations) which can execute a plurality of third party applications, one of which provides videoconferencing capabilities. Videoconferencing systems may be complex (such as the videoconferencing system shown in FIG. 1) or simple (e.g., a user computer system with a video camera, microphone and/or speakers). Thus, references to videoconferencing systems, endpoints, etc. herein may refer to general computer systems which execute videoconferencing applications or dedicated videoconferencing systems. Note further that references to the videoconferencing systems performing actions may refer to the videoconferencing application(s) executed by the videoconferencing systems performing the actions (i.e., being executed to perform the actions).

The videoconferencing system 103 may execute various videoconferencing application software that presents a graphical user interface (GUI) on the display 101. The GUI may be used to present an address book, contact list, list of previous callees (call list) and/or other information indicating other videoconferencing systems that the user may desire to call to conduct a videoconference.

Note that the videoconferencing system shown in FIG. 1 may be modified to be an audioconferencing system. The audioconferencing system, for example, may simply include speakerphones 105/107, although additional components may also be present. Additionally, note that any reference to a “conferencing system” or “conferencing systems” may refer to videoconferencing systems or audioconferencing systems (e.g., teleconferencing systems). Additionally, any references to “videoconferencing” may be modified to apply to audioconferencing as well (and vice versa).

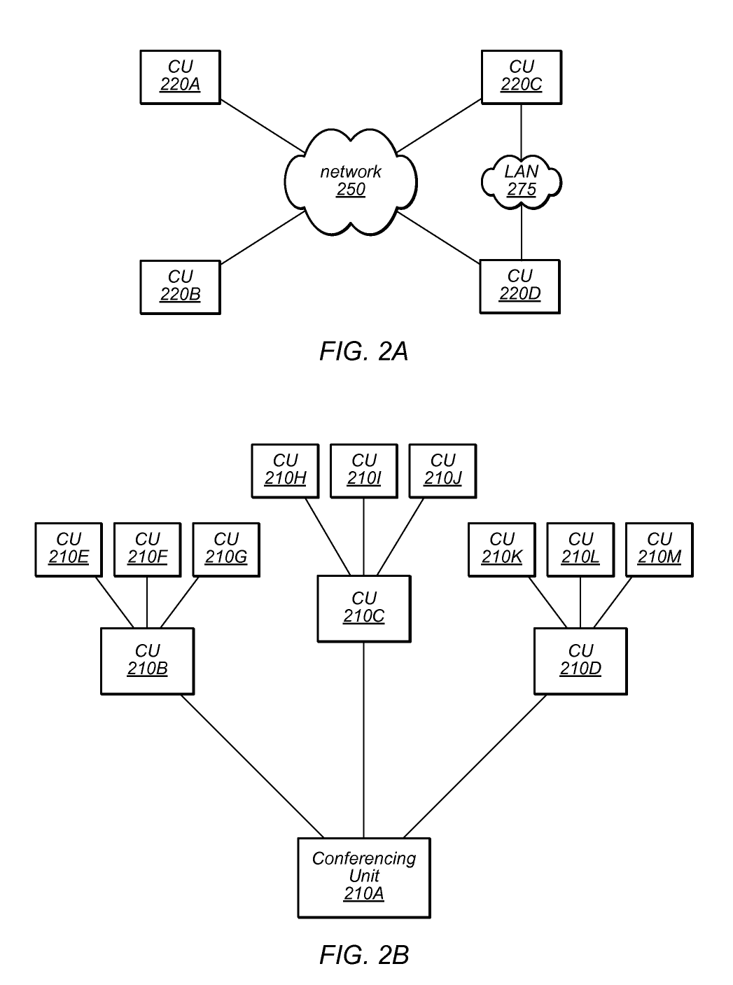

### FIGS. 2A and 2B—Coupled Conferencing Systems

FIGS. 2A and 2B illustrate different configurations of conferencing systems. As shown in FIG. 2A, conferencing systems (CUs) 220A-D (e.g., videoconferencing systems 103 described above) may be connected via network 250 (e.g., a wide area network such as the Internet) and CU 220C and 220D may be coupled over a local area network (LAN) 275. The networks may be any type of network (e.g., wired or wireless) as desired. In some embodiments, a server system may be interposed between conferencing units on the local network 275 (e.g., conferencing units 220C and 220D) and the wide area network 250. The server system (e.g., a transit server) may provide or otherwise in assisting videoconferencing communication between the conferencing units 220C and 220D and conferencing units on the wide area network 250 (e.g., conferencing units 220A and 220B).

The server system may solve the NAT/Firewall traversal problem for local networks (e.g., enterprise networks). In some embodiments, the server system may be deployed on the public side of the enterprise network (e.g., the wide area network's side of the local area network 275). The network 275 endpoints may be registered to the server system. The signaling and media between the private network endpoints (e.g., conferencing units 220C and 220D) and a public network endpoint (e.g., conferencing unit 220A or 220B) may be routed through the server system. The server system may solve the NAT/Firewall issue using H.323/H.460 and SIP based protocols.

FIG. 2B illustrates a relationship view of conferencing systems 210A-210M. As shown, conferencing system 210A may be aware of CU 210B-210D, each of which may be aware of further CU's (210E-210G, 210H-210J, and 210K-210M respectively). CU 210A may be operable to automatically determine a configuration for a conference according to the methods described herein, among others. In a similar manner, each of the other CUs shown in FIG. 2B, such as CU 210H, may be able to also automatically determine configurations for a conference, as described in more detail below. Similar remarks apply to CUs 220A-D in FIG. 2A.

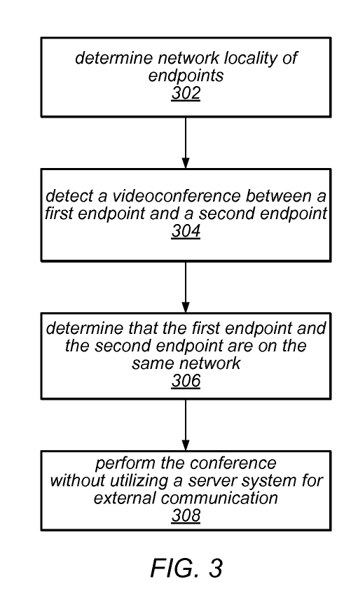

### FIG. 3—Routing Videoconference Signals for a Videoconference

FIG. 3 illustrates a method for routing videoconferencing signals for a videoconference. The method shown in FIG. 3 may be used in conjunction with any of the computer systems or devices shown in the above Figures, among other devices. In various embodiments, some of the method elements shown may be performed concurrently, performed in a different order than shown, or omitted. Additional method elements may also be performed as desired. As shown, this method may operate as follows.

In 302, network locality for videoconferencing units (referred to herein as “endpoints”) may be determined. As used herein, the “network locality” of a device refers to the network(s) to which the device belongs. Thus, the method may determine the network of each of a plurality of endpoints. For example, a server system, such as the transit server described above, may store the addresses (e.g., IP addresses) for the endpoints in a configuration file. The addresses may be used to determine network locality (e.g., common networks) among the endpoints. For example, two endpoints may be on a same or common network if they each have an address within a same range of addresses. In some embodiments, the server system may be local to a network for which it provides external communication of videoconferences. Thus, in one embodiment, each endpoint on the network may register itself with the server system, thereby specifying its address as being local to the network with the server system.

In various embodiments, the addresses may be determined in an automatic fashion or may be determined based on input received from a user. Alternatively or additionally, the method may include specifying (e.g., by a user) a range of addresses as being local to a network (e.g., the local network of the server system). For example, an administrator may specify that all addresses in 192.168.x.x (or specify a range within 192.168.x.x) are local to the network. Accordingly, in one embodiment, the server system may use the start and end address in the range of addresses to build a map of the local network. However, in some embodiments, there may be more than one range of addresses that are local to the network. For example, a plurality of sub-private networks may form a larger private network (e.g., the local network described herein). Thus, a plurality of different ranges may be specified as being local to the network.

Alternatively, or additionally, the server system may automatically determine the range of addresses (or sets of ranges of addresses) that are local to the network, e.g., by discovering devices (and/or addresses of devices) coupled to the network. Upon discovery, a topology or configuration of the network may be determined for future routing of videoconference packets, as described in 306 below. In one embodiment, the addresses may be automatically determined based on standard configured private networks (e.g., RFC 1918).

In 304, a videoconference may be requested or otherwise detected between a first endpoint and a second endpoint. The detection may be performed by the server system described above, although other systems are envisioned. In some embodiments, the detection may be performed based on packets received from the first endpoint and/or the second endpoint by the server system. The packets may be for initializing the videoconference or they may be data packets of the videoconference (e.g., RTP packets). In one embodiment, the server system may receive signaling packets, e.g., H.225 signaling packets, from the first and/or the second endpoint, which may be usable in the determination in 306.

In 306, the method may determine that the first endpoint and the second endpoint are within the same network (e.g., the local network described above). For example, as indicated above, the server system may receive signaling packets, e.g., H.225 signaling packets, which may include an address of the originating endpoint and/or the participating endpoints (e.g., the first and/or second endpoint). Thus, the server system may determine the address (e.g., the IP address) of the first and/or the second endpoint by examining the signaling packets. This method of determination may be referred to as a source mechanism, although other embodiments are envisioned. For example, the server system may utilize a stun mechanism. With the stun mechanism, the server system may use ICE/STUN (session traversal utilities for NAT, IETF standard) in conjunction with the session initiation protocol (SIP) to determine the first and/or second endpoint address. Thus, in some embodiments, this mechanism may be used in conjunction with H.323 to determine the address of the first and/or second endpoint, as desired.

The server system may determine that the addresses (e.g., the IP addresses) are within the configuration file or range of IP addresses previously determined and stored in 302 above. Thus, an endpoint whose address falls within the range of the start and end address of the range(s) may be considered a private address or part of the local network. Accordingly, if the first endpoint and the second endpoint are both within the same local network (e.g., the same address range or space), then the server system may determine that the first endpoint and the second endpoint are within the same network. Thus, the determination may be performed automatically and may be based on the address of the first endpoint and the second endpoint.

However, it should be noted that the determination that the endpoints are in the same local network may be performed dynamically at the time that the videoconference is detected or requested in 304, rather than before. In other words, 302 may be performed before the detection or may be performed in a dynamic fashion upon each determination of a videoconference, as desired.

In 308, the first endpoint and the second endpoint may not utilize the server system to transmit videoconference data of the videoconference between each other. For example, the first endpoint and the second endpoint may communicate directly via the local network rather than using the external server system or sending data outside of the local network. In some embodiments, this may be performed in response to an indication provided by the server system that the two endpoints (the first and second endpoints) are on the same server and that they should communicate with each other without using the server system. Thus, the first endpoint and the second endpoint may transmit videoconference data (e.g., using a real-time transport protocol (RTP) for audio and visual data of the videoconference) in a more efficient manner based on the determination in 306.

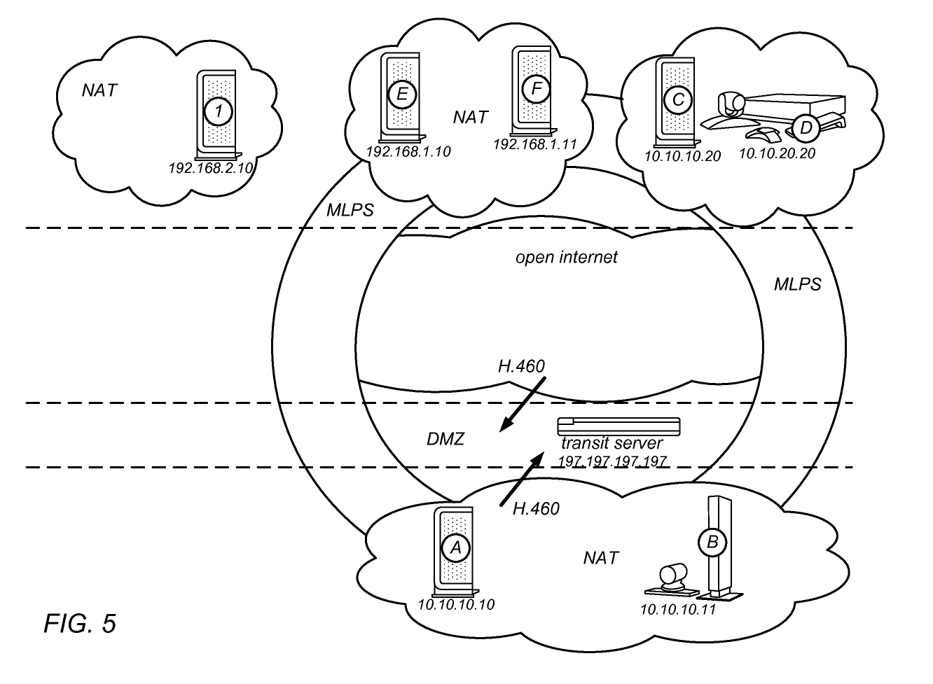

Note that the above method may be applied to videoconferences which include more than two endpoints. For example, the method may apply to any number of endpoints. FIGS. 5-8, described below, provide several use cases for a plurality of endpoints in a videoconference and include examples where all of the plurality of endpoints are within the same local network and examples where some of the endpoints are not within the local network.

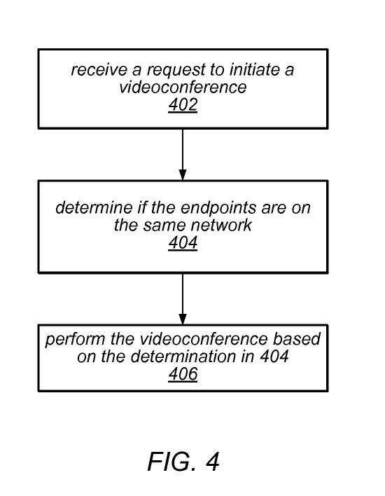

### FIG. 4—Endpoint Determination of Locality for a Videoconference

FIG. 4 illustrates a method for performing a videoconference based on locality of endpoints. The method shown in FIG. 4 may be used in conjunction with any of the computer systems or devices shown in the above Figures, among other devices. In various embodiments, some of the method elements shown may be performed concurrently, performed in a different order than shown, or omitted. Additional method elements may also be performed as desired. As shown, this method may operate as follows.

In 402, a first endpoint may receive a request to initiate a videoconference with a second endpoint. According to various embodiments, the first endpoint may receive the request from a user (e.g., selecting the second endpoint and selecting a “call” button using software executing on the first endpoint) or from another device or system (e.g., an external computer system, such as a scheduling system, or from the second endpoint, which may be initiating the videoconference). The request of the initiation of the videoconference may include an address (e.g., an IP address) of the first and/or the second endpoint.

In 404, the first endpoint may determine whether the second endpoint is within a same network as the first endpoint. 404 may be performed similar to the methods described above in FIG. 3. For example, the first endpoint may be configured (e.g., including specification of address ranges, of devices on a local network, etc.) or may otherwise determine (e.g., automatically) what address ranges or endpoints are within its local network, as described in 302 and 306 above. Thus, any of the methods described above may be utilized to determine whether the second endpoint is within the same network as the first endpoint, including previous configurations or determinations of network locality.

In 406, the videoconference may be initiated and/or performed based on the determination in 404. More specifically, if the second endpoint is not within the same network, the endpoint (e.g., software executing on the endpoint) may use a server system, such as the server system described above). As already indicated, the server system may provide H.323 or H.460 services for calling a public endpoint. However, if the second endpoint is within the same network as the first endpoint, the first endpoint may not use the server system, but may instead communicate with the second endpoint within the network (e.g., in a direct fashion, without using a server system or routing traffic outside of the local network).

Similar to above, the method of FIG. 4 may also be extended to any number of endpoints. The examples of FIGS. 5-8, provided below, may be handled using the method of FIG. 4.

FIGS. 5-8—Exemplary Screen Shots According to the Method of FIG. 3

FIGS. 5-8 are exemplary screen shots corresponding to the method of FIG. 3, according to various embodiments. These Figures (and their corresponding descriptions) may apply to any of the systems and methods described above.

As shown in FIG. 5, a transit server with IP address 197.197.197.197 is included within the DMZ. Satellite sites A, B, C, D, E, and F are included within local network MPLS. In this case, each endpoint inside the MPLS network can pass signaling and media traffic to one another on this network without use of any firewall traversal products, such as the transit server. Each endpoint may be registered to the transit server's embedded gatekeeper with H.460 registration. Note that two different IP address ranges are included in the MPLS network, 192.168.1.x and 10.10.x.x. Thus, the transit server may be configured (or may have otherwise automatically determined) that any endpoint in these two address ranges may be within the MPLS network.

In a first example of the system shown in FIG. 5, endpoint A may call any subset of B/C/D/E/F by dialing the respective IP address or GKID address (among other methods) of the endpoint. Accordingly, since these endpoints are all within the same network, communication may flow within the MPLS network (e.g., directly between the respective endpoints) and the transit server may not be used, e.g., for NAT/firewall traversal. The determination that the call is within the same network may be performed by the transit server (e.g., following the method of FIG. 3) or by the endpoint (e.g., following the method of FIG. 4), as desired.

In a second example, endpoint A may initiate a multipoint videoconference by calling endpoint B and endpoint C. The videoconference data may be passed within the MPLS network and may not use the transit server, similar to the first example of FIG. 5. However, endpoint A may then add endpoint 1 by dialing an address for endpoint 1 (in this case, 192.168.2.10). Accordingly, traffic to/from endpoint 1 may be passed through the transit server. However, traffic between A, B, and C may not use the transit server.

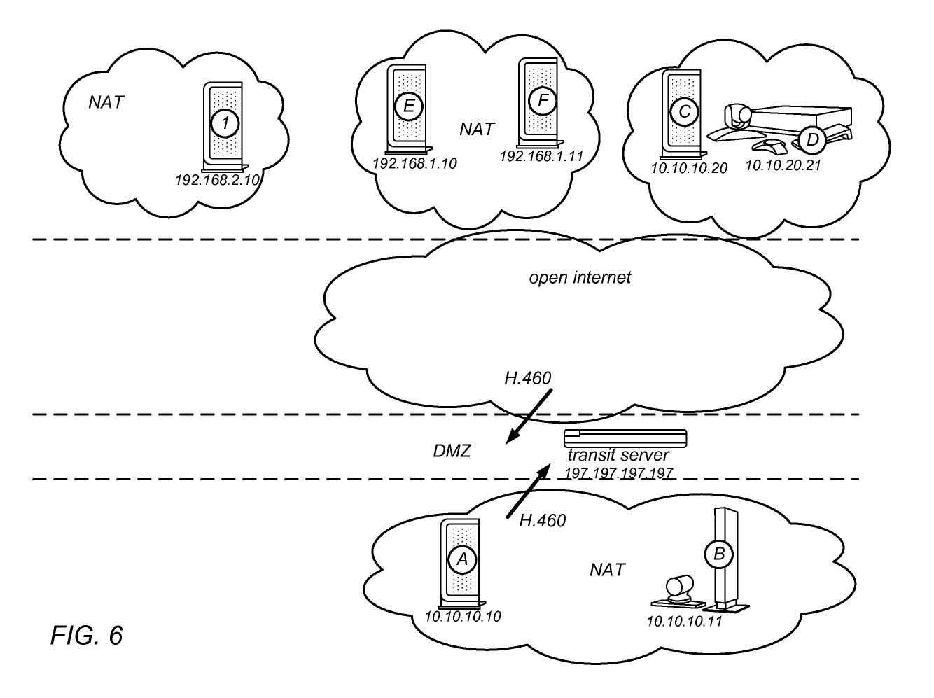

FIG. 6 illustrates another system similar to FIG. 5, except without the MPLS network. In this embodiment, A and B are within a common network, C and D are within a common network, E and F are within a common network, and 1 is within its own network.

In a first example, endpoint A may establish a videoconference with endpoint B. Since both of these endpoints are within the same network, the transit server may not be used.

In a second example, endpoint A may establish a videoconference with endpoint D. Since these endpoints are not within the same network, the transit server may be used.

In a third example, endpoint A may establish a videoconference with endpoint B and endpoint D. In this case, communication between A and B may not use the transit server, but any communication with D may use the transit server.

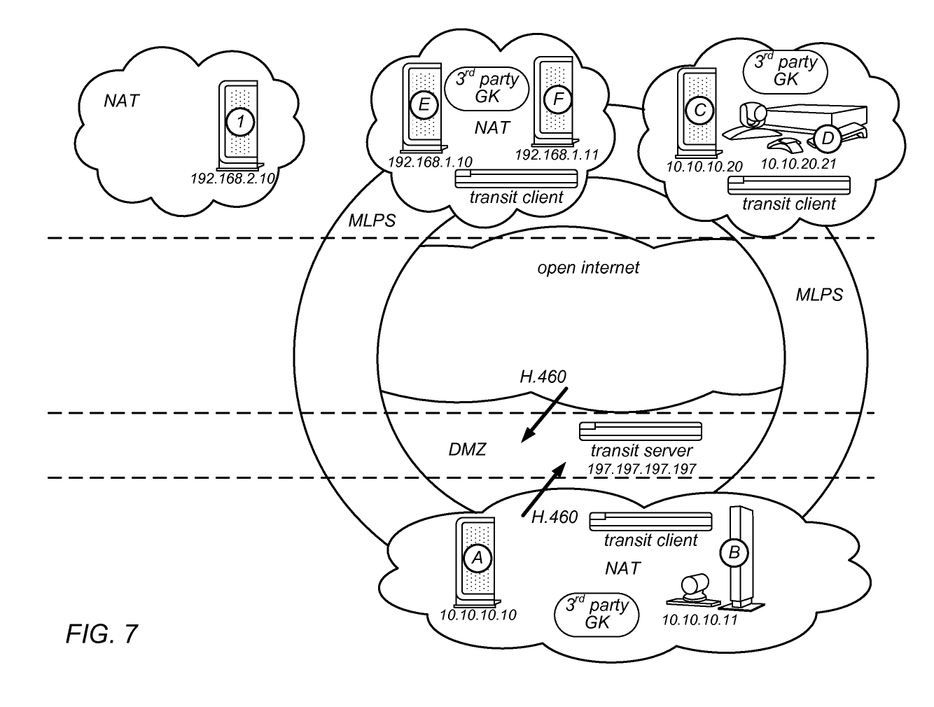

FIG. 7 illustrates a system where a transit client is added to the networks of A and B, C and D, and E and F, respectively. In this case, each endpoint is registered to its respective transit client (for endpoints A-F), and each transit client is registered to the transit server, e.g., using H.460 or H.323 tunneling.

In a first example, endpoint A may establish a videoconference with endpoint C and the transit server may not be used since they are both local to the MPLS network.

In a second example, endpoint A may establish a videoconference with endpoints B and C. In this case, the transit server may not be used since all three are local to the MPLS network. However, upon adding endpoint 1 to the videoconference, any data to/from 1 may use the transit client(s) and server, but any data between endpoints A-C may not use the transit server.

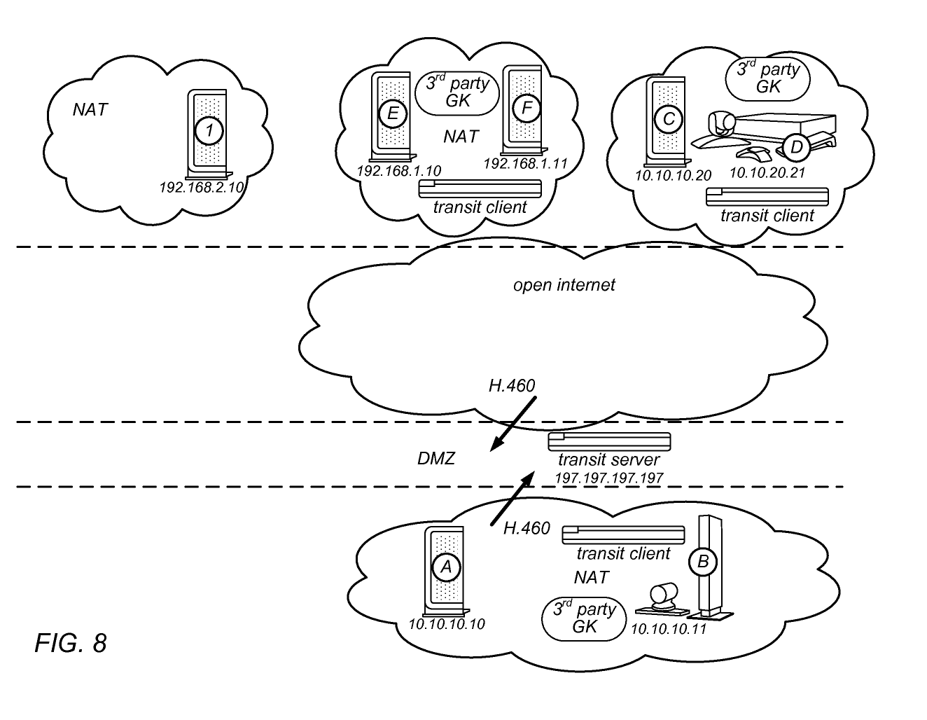

FIG. 8 illustrates a system similar to FIG. 7 (with transit clients and the transit server), except without the MPLS network, similar to FIG. 6.

In a first example, endpoint A may establish a videoconference with endpoint B. Since both of these endpoints are within the same network, the transit client and server may not be used.

In a second example, endpoint A may establish a videoconference with endpoint D. Since these endpoints are not within the same network, the transit clients and server may be used.

In a third example, endpoint A may establish a videoconference with endpoint B and endpoint D. In this case, communication between A and B may not use the transit client and server, but any communication with D may use the transit clients and server.

### ADVANTAGES

The above described methods may have advantages over prior systems, such as those indicated in the Background section above. For example, current H.460 specifications may require RTP streams to be routed through an H.460 server. By performing the methods above, use cases where the RTP stream is sent to an externally placed H.460 server for calls between endpoints in the same private address space may be avoided. Thus, the RTP stream, using the methods described above, may not be sent external to the private network and then routed back in, and may instead take a direct path between the two (or more) endpoints. Thus, network resources may be used more efficiently in such cases by avoiding the use of a server system (e.g., the transit server) described above and by decreasing external network use and routing associated therewith.

Embodiments of a subset or all (and portions or all) of the above may be implemented by program instructions stored in a memory medium or carrier medium and executed by a processor. A memory medium may include any of various types of memory devices or storage devices. The term “memory medium” is intended to include an installation medium, e.g., a Compact Disc Read Only Memory (CD-ROM), floppy disks, or tape device; a computer system memory or random access memory such as Dynamic Random Access Memory (DRAM), Double Data Rate Random Access Memory (DDR RAM), Static Random Access Memory (SRAM), Extended Data Out Random Access Memory (EDO RAM), Rambus Random Access Memory (RAM), etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer that connects to the first computer over a network, such as the Internet. In the latter instance, the second computer may provide program instructions to the first computer for execution. The term “memory medium” may include two or more memory mediums that may reside in different locations, e.g., in different computers that are connected over a network.

In some embodiments, a computer system at a respective participant location may include a memory medium(s) on which one or more computer programs or software components according to one embodiment of the present invention may be stored. For example, the memory medium may store one or more programs that are executable to perform the methods described herein. The memory medium may also store operating system software, as well as other software for operation of the computer system.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A method for routing videoconference signals, comprising:
a server system detecting a videoconference between a first endpoint and a second endpoint, wherein the first endpoint and the second endpoint are on a same network, wherein the server system is configured to provide videoconference communication external to the network for the first endpoint and the second endpoint;
the server system determining that the first endpoint and the second endpoint are within the same network;
the server system providing an indication to the first endpoint to provide videoconferencing signals of the videoconference to the second endpoint within the same network without utilizing the server system, wherein after providing the indication, the first endpoint provides the videoconferencing signals of the videoconference to the second endpoint without using the server system.

2. The method of claim 1, wherein said detecting the videoconference comprises the server system receiving a request to establish the videoconference between the first endpoint and the second endpoint.

3. The method of claim 2, wherein the request is received from the first endpoint.

4. The method of claim 1, wherein said determining is performed automatically based on an IP address of the first endpoint and an IP address of the second endpoint.

5. The method of claim 1, wherein said determining is based on a configuration file which defines a range of IP addresses that are common to the same network, and wherein an IP address of the first endpoint and an IP address of the second endpoint fall within the range of IP addresses.

6. The method of claim 5, further comprising:
the server system automatically determining the range of IP addresses that are common to the same network.

7. The method of claim 6, further comprising:
the server system receiving the range of IP address that are common to the same network based on user input.

8. A computer accessible memory medium storing program instructions for routing videoconference signals, wherein the program instructions are executable to:
detect a videoconference between a first endpoint and a second endpoint, wherein the first endpoint and the second endpoint are on a same network, wherein the server system is configured to provide videoconference communication external to the network for the first endpoint and the second endpoint;
determine that the first endpoint and the second endpoint are within the same network; and
provide an indication to the first endpoint to provide videoconferencing signals of the videoconference to the second endpoint within the same network without utilizing the server system, wherein after providing the indication, the first endpoint provides the videoconferencing signals of the videoconference to the second endpoint without using the server system.

9. The memory medium of claim 8, wherein said determining is performed automatically based on an IP address of the first endpoint and an IP address of the second endpoint.

10. The memory medium of claim 8, wherein said determining is based on a configuration file which defines a range of IP addresses that are common to the same network, and wherein an IP address of the first endpoint and an IP address of the second endpoint fall within the range of IP addresses.

11. The memory medium of claim 10, wherein the program instructions are further executable to:
automatically determine the range of IP addresses that are common to the same network.

12. The memory medium of claim 10, wherein the program instructions are further executable to:
receive the range of IP address that are common to the same network based on user input.

13. A computer-accessible memory medium storing program instructions for routing videoconference signals, wherein the program instructions are executable by a processor to:
initiate a videoconference between a first endpoint and a second endpoint utilizing a server system, wherein the first endpoint and the second endpoint are on a same network, wherein the server system is configured to provide videoconference communication external to the network for the first endpoint and the second endpoint;
receive an indication from the server system to provide videoconferencing signals of the videoconference to the second endpoint within the same network without utilizing the server system;
provide the videoconferencing signals of the videoconference to the second endpoint without using the server system.

14. A method for establishing a videoconference, comprising:
a first endpoint receiving a request to establish the videoconference, wherein the request comprises an address of a second endpoint;
determining if the second endpoint is within a same network as the first endpoint based on the address of the second endpoint;
establishing the videoconference with the second endpoint based on said determining, wherein said establishing comprises using an external communication server if the second endpoint is not within the same network as the first endpoint, and wherein said establishing comprises bypassing the external communication server if the second endpoint is within the same network as the first endpoint.

15. The method of claim 14, wherein the address comprises an IP address.

16. The method of claim 14, wherein said determining is based on a configuration file which defines a range of addresses that are common to the same network and wherein the address of the second endpoint fall within the range of IP addresses.

17. The method of claim 16, further comprising:
the first endpoint automatically determining the range of addresses that are common to the same network.

18. The method of claim 16, further comprising:
the first endpoint receiving the range of address that are common to the same network based on user input.

19. A memory medium storing program instructions for establishing a videoconference, wherein the program instructions are executable by a processor to:
receive a request to establish the videoconference, wherein the request comprises an address of an endpoint;
determine if the endpoint is within a same network based on the address of the second endpoint;
establish the videoconference with the second endpoint based on said determining, wherein said establishing comprises using an external communication server if the second endpoint is not within the same network, and wherein said establishing comprises bypassing the external communication server if the second endpoint is within the same network.

20. The memory medium of claim 19, wherein the address comprises an IP address.

21. The memory medium of claim 19, wherein said determining is based on a configuration file which defines a range of addresses that are common to the same network and wherein the address of the second endpoint fall within the range of IP addresses.

22. The memory medium of claim 21, wherein the program instructions are further executable to:
automatically determine the range of addresses that are common to the same network.

23. The memory medium of claim 21, wherein the program instructions are further executable to:
receive the range of address that are common to the same network based on user input.
